(19) United States
(12) Patent Application Publication
(10) Pub. No.: US 2011/0258032 A1
(43) Pub. Date: Oct. 20, 2011

(54) SEARCH ADVERTISEMENT SELECTION BASED ON USER ACTIONS

(75) Inventors: VISWANATH VADLAMANI, REDMOND, WA (US); ABHINAI SRIVASTAVA, SEATTLE, WA (US); TAREK NAJM, KIRKLAND, WA (US); ARUNGUNRAM CHANDRASEKARAN SURENDRAN, SAMMAMISH, WA (US); RAJEEV PRASAD, BOTHELL, WA (US); MAHBUBUL ALAM ALI, REDMOND, WA (US)

(73) Assignee: MICROSOFT CORPORATION, REDMOND, WA (US)

(21) Appl. No.: 12/759,879

(22) Filed: Apr. 14, 2010

(51) Int. Cl. G06Q 30/00; G06F 17/30; G06Q 10/00

(52) U.S. Cl. 705/14.42; 705/14.54; 707/769; 707/765; 707/E17.074; 707/E17.014

(57) ABSTRACT

Advertisements are selected for presentation on a search results page based on the presence or absence of user activity within the search results page. When a search results page is provided to an end user, the search results page is tracked for user activity. If user activity is detected, a user context is identified and new advertisements are selected for presentation on the search results page based on the user context. In some embodiments, the search results page provides search results in clusters, and the user context corresponds with a search result cluster selected by an end user. In some embodiments, dominant concepts in the user context are identified and used to select advertisements. Alternatively, if user activity is not detected within a predetermined period of time, new advertisements are selected based on the absence of user activity within the search results page.

### BACKGROUND

Advertising is an established way for merchants to reach an audience of potential customers. Ideally, merchants desire to have their advertisements directed to individuals that are likely to purchase the merchants' products and services. Accordingly, advertising has gone through an evolution of targeting approaches. Initially, advertising was often generally untargeted. However, over time, merchants began to target potential customers in a number of ways. For instance, merchants often target a particular audience by selectively choosing the medium (e.g., newspapers, magazines, radio, television, etc.) in which to advertise. Additionally, advertising is often targeted by selecting the particular environment (e.g., specific shows on television, specific web pages on the Internet, etc.) within which the advertisements will appear.

Search advertising, in which advertisements are presented in conjunction with search results in response to user search queries, is a more recent form of advertising. Search advertising is often considered to be a targeted form of advertising because the advertisements are directed to the specific user search queries. In particular, when an end user submits a search query to a search engine, keywords are identified based on the terms of the search query and/or based on content of the search results. The keywords are used for selecting advertisements that are presented in conjunction with the search results on a search results page returned in response to the end user's query. Although advertisements are selected based on relevance to the end users' search queries, end users may not be interested in the advertisements selected and presented in conjunction with the search results. Nonetheless, the advertisements are static on the search results page and only reflect relevance to the search query.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing advertisements based on user activity or inactivity corresponding with search results. Search results are provided for presentation to an end user and tracked for user activity. If user activity is detected, new advertisements may be selected based on a user context, which comprises a context gleaned from the user activity. In some embodiments, the search results are provided in clusters, and the user context corresponds with search results of a cluster selected by the end user. In some embodiments, dominant concepts are identified from the user context using a concept graph, and advertisements are selected based on the dominant concepts. In further embodiments, new advertisements may be provided in response to the absence of user activity. If no user activity is detected for a predetermined period of time, new advertisements may be selected based on the absence of user activity. New advertisements may be used to replace advertisements currently displayed on the search results page.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a flow diagram showing a method for selecting an advertisement based on a user context in a search results page in accordance with an embodiment of the present invention;

FIG. 4 is a flow diagram showing a method for replacing advertisements in a search results page based on user context in accordance with an embodiment of the present invention;

FIG. 5 is a flow diagram showing a method for providing advertisements based on user actions corresponding with search result clusters in accordance with an embodiment of the present invention;

FIGS. 6A and 6B are illustrative screen displays showing a search results page with different advertisements based on user context in accordance with an embodiment of the present invention;

FIG. 7 is a flow diagram showing a method for selecting keywords for advertisement selection based on dominant concepts in a user context of a search results page in accordance with an embodiment of the present invention;

FIG. 8 is a flow diagram showing a method for replacing advertisements in a search results page based on user inactivity in accordance with an embodiment of the present invention; and

FIG. 9 is a flow diagram showing a method for replacing advertisements in a search results page based on user activity or inactivity in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As previously indicated, embodiments of the present invention are generally directed to providing, modifying, and/or updating advertisements for presentation to end users based on the presence or absence of user activity corresponding with search results. When a search query is received from an end user, search results relevant to the user's search query are provided in response. In addition to search results, advertisements may be selected based on the user's search query and provided for presentation in conjunction with the search results. The presence or absence of user activity is then tracked. Embodiments of the present invention track user activity that occurs after a search query is received from the end user and includes tracking activity that does not change the context of the original search query. For instance, in some embodiments, a search results page may be provided that includes search results aggregated into different clusters, and the end user may select a particular cluster to view search results on the search results page. The selection doesn't change the context of the original search query. As such, the end user can perform a number of actions on the search results page while remaining within the context of the original search query.

In some instances, the search results and/or advertisements may be provided to the end user on a search results page. In other instances, the search results and/or advertisements may be provided in another environment. Accordingly, although embodiments are primarily discussed herein in which search results and/or advertisements are provided on a search results page, other embodiments include providing search results and/or advertisements in other environments. Additionally, although embodiments are primarily discussed herein in which a search results page is tracked for user activity, other embodiments include tracking user activity in other environments and/or outside of a search results page.

When an end user performs an action on the search results page or otherwise, a new user context is provided by the user action. For instance, in an embodiment in which search result clusters are provided, when an end user selects a particular cluster, the user context may include the selected cluster and/or the search results of that cluster. However, as noted above, the query context remains the same regardless of the user selection. The user actions and user context provide an indication of the end user's interest and therefore provides better information for selecting advertisements in which the end user may be interested. When a user action is detected, a user context is identified and used to select new advertisements. In some embodiments, dominant concepts within the user context are identified using a concept graph and employed to select advertisements. The newly selected advertisements may replace advertisements previously presented on the search results page. As such, as the user performs actions on the search results page, advertisements that correspond with the user context of the search results page are presented.

Further embodiments of the present invention select new advertisements for presentation on a search results page based on the absence of user activity for a predetermined period of time. This recognizes that if an end user does not select an advertisement on a search results page after a certain period of time, the end user is not likely interested in that advertisement. As such, if no user activity is detected within a search results page for a predetermined period of time, new advertisements are selected based on the inactivity and are used to replace advertisements currently displayed on the search results page.

Accordingly, in one aspect, an embodiment of the present invention is directed to one or more computer-readable media storing computer-useable instructions that, when used by one or more computing devices, cause the one or more computing devices to perform a method. The method includes receiving a search query submitted by an end user. The method also includes providing a plurality of search results in response to the search query submitted by the end user, wherein the plurality of search results are grouped into a plurality of clusters, each cluster including a different subset of search results. The method further includes identifying a user activity corresponding with one of the plurality of clusters, the user activity being indicative of user interest in a selected cluster. The method also includes identifying a user context based on the selected cluster. The method further includes selecting one or more advertisements for presentation based on the user context. The method still further includes providing the one or more advertisements for presentation to the end user.

In another embodiment, an aspect of the invention is directed to one or more computer-readable media storing computer-useable instructions that, when used by one or more computing devices, cause the one or more computing devices to perform a method. The method includes receiving a search query submitted by an end user and providing a search results page for presentation to the end user in response to the search query submitted by the end user, the search results page including a plurality of search results and an initial advertisement selected based at least in part on the search query submitted by the end user. The method also includes tracking the search results page for user activity and detecting a user action by the end user within the search results page. The method further includes identifying a user context based on the user action in response to detecting a user action within the search results page. The method also includes identifying a set of search results within the user context, identifying a plurality of concepts within text corresponding with the set of search results, and analyzing the plurality of concepts using a concept graph to identify one or more dominant concepts. The method further includes selecting one or more keywords based on the one more dominant concepts and selecting a new advertisement based on the one or more keywords. The method still further includes replacing the initial advertisement within the search results page with the new advertisement.

A further embodiment of the present invention is directed to one or more computer-readable media storing computer-useable instructions that, when used by one or more computing devices, cause the one or more computing devices to perform a method. The method includes receiving a search query submitted by an end user. The method also includes providing a search results page in response to the search query, the search results page including a plurality of search results and an initial advertisement. The method further includes determining that a predetermined time period has expired without detecting user activity within the search results page. The method also includes selecting a new advertisement in response to determining that the predetermined time period has expired without detecting user activity within the search results page. The method further includes replacing the initial advertisement within the search results page with the new advertisement.

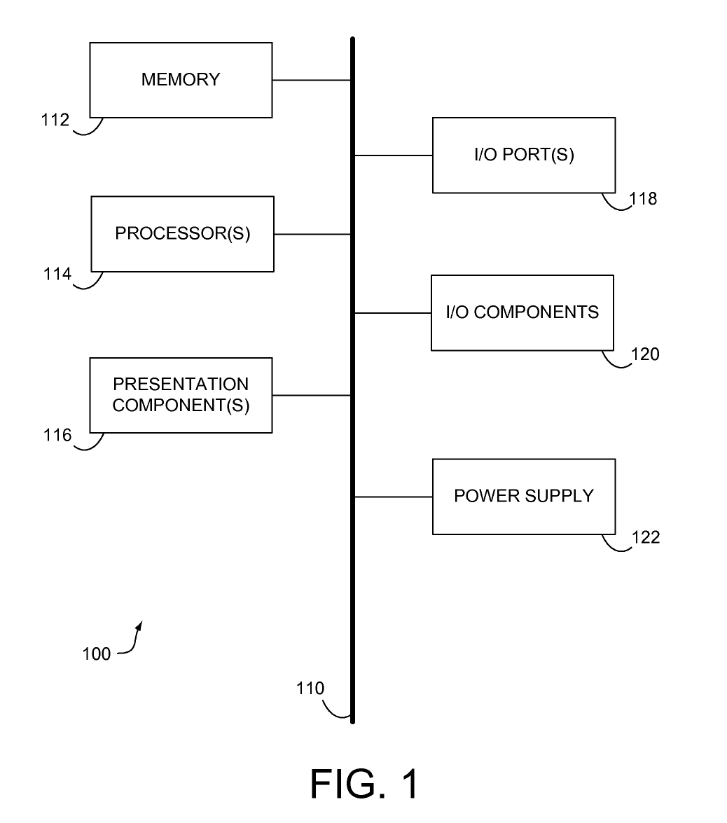

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/ components 120. Presentation component(s) 116 present data indications to an end user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

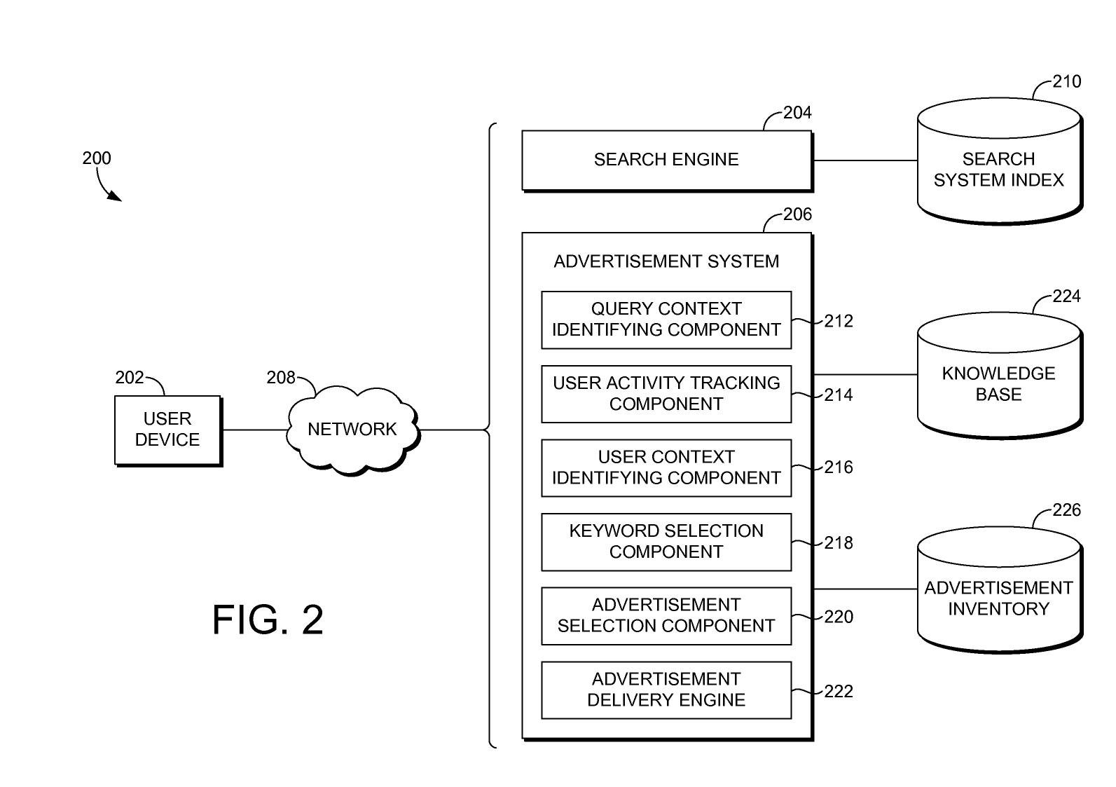

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a user device 202, a search engine 204, and an advertisement system 206. Each of the components shown in FIG. 2 may be embodied on any type of computing device, such as computing device 100 described with reference to FIG. 1, for example. The components may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of user devices, search engines, and advertisement systems may be employed within the system 200 within the scope of the present invention. Each may comprise a single device or multiple devices cooperating in a distributed environment. For instance, the system 200 may comprise multiple devices arranged in a distributed environment that collectively provide the functionality of the search engine 204 and advertisement system 206 described herein. Additionally, other components not shown may also be included within the system 200.

In accordance with embodiments of the present invention, a user may employ the user device 202 to submit search queries to the search engine 204 and, in response, receive search results and advertisements. For instance, the user may employ a web browser on the user device 202 to access a search input web page and enter a search query. As another example, the user may enter a search query via a search input box provided by a search engine toolbar located, for instance, within a web browser, the desktop of the user device 202, or other location. One skilled in the art will recognize that a variety of other approaches may also be employed for providing a search query within the scope of embodiments of the present invention.

When the search engine 204 receives a search query from a user device, such as the user device 202, the search engine 204 performs a search on a search system index 210 and/or other data storage containing searchable content. Accordingly, the search engine 204 identifies a number of search results in response to the received search query. In some embodiments, as will be described in further detail below, the search engine 204 may also aggregate the search results into a number of clusters and provide a search results page that allows an end user to navigate the clusters.

Advertisements are also selected by the advertisement system 206 for inclusion in the search results page as will be described in further detail below. A search results page that includes search results with selected advertisements is returned to the user device 202 in response to the search query. As will be described in further detail below, the end user may perform actions on the search results page or otherwise that trigger new user contexts. Each time a new user context is identified, the advertisement system 206 selects new advertisements for presentation on the search results page. Additionally, the advertisement system 206 may identify user inactivity for a threshold period of time and select new advertisements for presentation based on the absence of user activity.

As shown in FIG. 2, the advertisement system 206 includes a query context identifying component 212, a user activity tracking component 214, a user context identifying component 216, a keyword selection component 218, an advertisement selection component 220, and an advertisement delivery engine 222. The query context identifying component 212 operates to identify the query context for a search query received from a user device, such as the user device 202. The query context may include one or more search terms of the search query. In some embodiments, the query context may include other information, such as, for instance, the time at which the search query was submitted or the location of the end user submitting the search query. Other information may also be identified as part of the query context. The query context may be used for advertisement selection. For instance, when a search query is received, the query context may be used to select initial advertisements for presentation on the search results page before any user action is identified. In some embodiments, the query context may also be used to select advertisements in conjunction with a user context identified after a user action on the search results page.

The user activity tracking component 214 operates to track user activity on the search results page. The identification of user activity on the search results page triggers identification of a user context by the user context identifying component 216 and selection of new advertisements by the advertisement selection component 220. Any user action within a search result page or otherwise that provides further context for selecting advertisements may be employed within embodiments of the present invention. By way of example only and not limitation, in some embodiments, the search results page may aggregate search results into different clusters. When an end user selects to view a particular cluster, the selection of that cluster is viewed as a user action providing context for selecting advertisements. In particular, the search results within the selected cluster provide further context for advertisement selection. As another example, an end user may perform an action that indicates interest in a particular search result, such as hovering a cursor over a search result or selecting a control causing additional information regarding a search result to be displayed within the search results page. The user action would indicate end user interest in the particular search result providing further context for advertisement selection. A variety of additional user actions within a search results page may also be used to provide further context for advertisement selection in accordance with various embodiments of the present invention. Additionally, in some embodiments user actions outside a search results page may be tracked and used to determine the user context. For instance, an end user's physical change in location (e.g., as tracked by a GPS function of a mobile device) may be an action that defines a new user context.

In some embodiments, the user activities to be tracked by the user activity tracking component 214 to determine whether any user action has occurred may be configurable by the search system provider. For instance, some user activities, such as scrolling up and down a window may not be considered as a user action within the search results page. However, other user activities such as selecting a search result or an advertisement would be considered a user action. In some embodiments, only actions that change the context of the search results page are considered and tracked.

The keyword selection component 218 selects keywords based on the user context identified by the user context identifying component 216. In some embodiments, the keyword selection component 218 selects keywords based only on a current user context. In other embodiments, the keyword selection component 218 selects keywords based on previous user contexts in addition to the current user context. For instance, an end user may perform multiple actions within a search results page, each action resulting in a different user context. As noted above, the query context may be also be used in conjunction with the user context to select keywords.

In some embodiments of the present invention, the keyword selection component 218 selects keywords by identifying dominant concepts within the user context using a concept graph stored in a knowledge base 224, as will be described in further detail below. The concept graph comprises a collection of concepts and relationships among the concepts. In particular, concepts are represented as nodes within the concept graph and relationships among the concepts are represented as edges between the nodes. Additionally, the edges are configured to represent the strength of relationships between concepts. The concept graph may be generated by mining data from a corpus of documents to identify concepts and the relationships of concepts and stored in the knowledge base 224.

The advertisement selection component 220 queries an advertisement inventory 226 using selected keywords to select advertisements that will be delivered for presentation. The advertisement inventory 226 may store advertisements and metadata associated with each advertisement. The metadata stored for an advertisement may include information used in advertisement selection, such as for instance, bid values from advertisers, click-through rates, etc. In embodiments of the present invention, the advertisement selection component 220 selects advertisements based on relevance of the advertisements to selected keywords and/or based on monetization (i.e., an estimate of the extent to which the advertisements will generate advertising revenue). Auction processes currently employed by advertising systems may be used for selecting advertisements. Such processes are well known to those skilled in the art and therefore will not be discussed in further detail herein.

The advertisement system 206 also includes an advertisement delivery engine 222 that facilitates delivery of selected advertisements for presentation. In embodiments, a search results page delivered to a user device, such as the user device 202, is configured such that advertisements presented on the search results page may be replaced. As such, when user activity is identified on the search results page and a new user context is determined, new advertisements are selected and delivered by the advertisement delivery engine 222 to replace previous advertisements presented on the search results page.

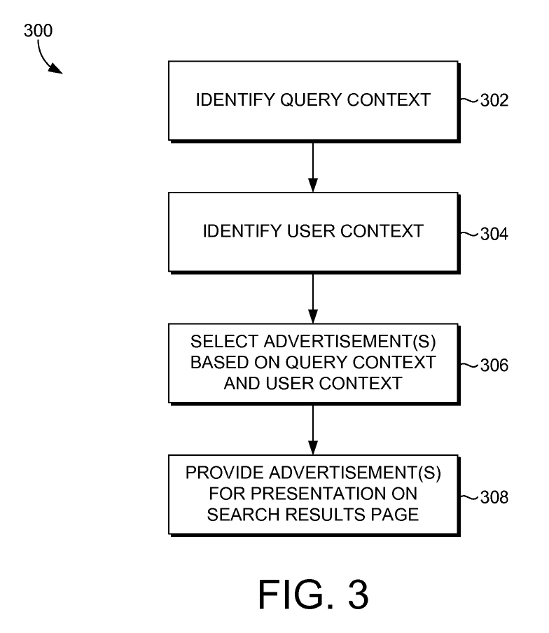

Turning to FIG. 3, a flow diagram is provided illustrating an overall method 300 for selecting an advertisement based on user actions within a search results page in accordance with an embodiment of the present invention. As shown at block 302, the method 300 includes identifying a query context. As discussed previously, the query context comprises information regarding the search query submitted by the end user. In some embodiments, the query context includes the search terms entered by the end user as a search query. In addition to or in lieu of search terms entered by the end user, the query context in some embodiments may include other information regarding a user search, such as, for instance, the time an end user submits a search or the location of the end user submitting the search. A variety of additional information regarding a search query submitted by an end user may be identified as part of the query context in various embodiments of the present invention.

In addition to identifying a query context, a user context is identified, as shown at block 304. The user context is based on user actions within a search results page or other environment. Any user action that provides further context for selecting advertisements may be employed within some embodiments of the present invention. By way of example only and not limitation, in some embodiments, the search results page may aggregate search results into different clusters. When an end user selects to view a particular cluster, the selection of that cluster is viewed as a user action providing context for selecting advertisements. The search results within the selected cluster may provide further context for advertisement selection. As another example, an end user may perform an action that indicates interest in a particular search result, such as hovering a cursor over a search result or selecting a control to cause additional information regarding a search result to be displayed within the search results page. The user action would indicate end user interest in the particular search result providing further context for advertisement selection. A variety of additional user actions within a search results page or other environments may also be used to provide further context for advertisement selection in accordance with various embodiments of the present invention.

In some embodiments, only the current user context corresponding with a current user action is identified at block 304. In other embodiments, a history of user contexts corresponding with a history of user actions within the search results page is identified at block 304. For instance, in an embodiment in which the search results page is provided with a number of clusters of search results, the end user may sequentially select clusters to view the subset of search results associated with each cluster. Each time the end user selects a cluster, a new user context is provided. As such, in some embodiments, the process may identify not only the current user context at block 304 based on the cluster currently selected by the end user, but also previous user contexts corresponding with clusters previously selected by the end user.

As shown at block 306, an advertisement is selected based on the identified query context and user context. Advertisements may be selected based on the query context and user context in a variety of different manners. In accordance with some embodiments of the present invention, one or more keywords are selected based on the query context and user context. For instance, in embodiments in which an end user selects a cluster of search results, keywords that are relevant to the original search query and the search results within the selected cluster are identified. As another example, in embodiments in which a user action indicates end user interest in a particular search result, keywords relevant to the original search query and identified search result are identified.

Keywords may be selected based on the current user context or based on a history of user contexts within the search result page. As an example of the former, keywords may be selected based only on a subset of search results corresponding with a currently selected cluster. As an example of the latter, keywords may be selected based on the subset of search results corresponding with each cluster the end user has selected within the search results page. In some embodiments, different weightings may be applied to each user context in the history of user contexts. For instance, a weighting may be applied based on the order of the user contexts in the history. Earlier user contexts may be given less weight than more recent user contexts, and the current user context may be given the greatest weighting. As another example, a weighting may be applied based on a length of time the end user views each user context. The longer the end user views a user context within the search results page, the greater the weighting for that user context. A variety of other weightings may be applied in various embodiments of the present invention.

In some embodiments, keyword selection may also take into account monetization considerations. In particular, the process may select keywords that will result in the selection of advertisements that are determined to be more likely to generate greater advertising revenue.

One or more keywords identified from the query context and user context are used to select an advertisement for presentation within the search results page. Any number of advertisements may be selected in accordance with various embodiments of the present invention. In some embodiments, the top N search results are selected and presented within the search results page. In other embodiments, search results satisfying a particular threshold of relevance to the keywords are selected. In further embodiments, search results having a relevance that is significantly greater than the relevance of other search results are selected. Any and all such variations are contemplated to be within the scope of embodiments of the present invention. The selected advertisements are provided for presentation on the search results page, as shown at block 308. In other embodiments, the selected advertisements may be presented in another environment.

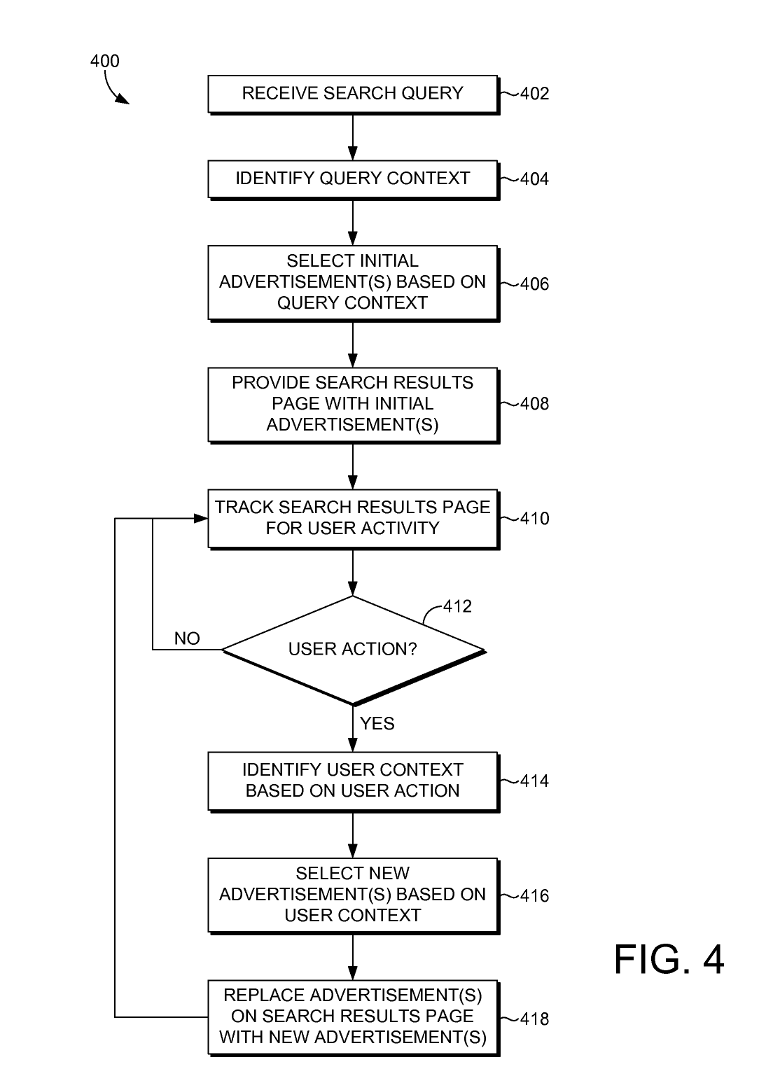

In embodiments, advertisements selected based on user actions can be used to replace advertisements currently displayed on the search results page or other environment. For instance, as an end user performs various actions within a search results page, the advertisements on the search results page may be replaced with each user action. Accordingly, referring next to FIG. 4, a flow diagram is provided that illustrates a method 400 for replacing advertisements displayed on a search results page in accordance with an embodiment of the present invention. As shown at block 402, a search query is received that may include one or more search terms. A query context is identified for the search query, as shown at block 404. The query context may include the one or more search terms of the search query. In some embodiments, the query context may include additional information regarding the search, such as, for instance, a time the search query was submitted or a location of the end user submitting the search query.

An initial set of one or more advertisements is selected based on the query context, as shown at block 406. A search results page that includes search results and the initial set of advertisements is generated and provided to the end user who submitted the search query, as shown at block 408.

After the search results page is provided to the end user, the search results page is tracked for user actions within the search results page, as shown at block 410. In some embodiments, some user activities, such as scrolling up and down a window may not be considered as a user action within the search results page. However, other user activities such as selecting a search result or an advertisement would be considered a user action. The user activities to be tracked to determine whether any user action has occurred for the purposes of the method 400 may be configurable by the search system provider.

A determination is made at block 412 regarding whether a user action has been made in the search results page. If a user action is not detected, the process continues to track the search results page for a user action. Alternatively, if a user action is detected, a user context is identified based on the user action, as shown at block 414.

A new set of one or more advertisements is selected based on the user context at block 416. At least one advertisement currently displayed within the search results page is replaced with a new advertisement, as shown at block 418. In some embodiments, only a single advertisement is displayed on the search results page, and the single advertisement is replaced with a new advertisement. In other embodiments, multiple advertisements are displayed on the search results page. In some instances, all advertisements are replaced with new advertisements. In other instances, only a portion of the advertisements are replaced with new advertisements.

As previously discussed, some embodiments are directed to providing advertisements for a search results page that aggregates search results into clusters. As used herein, the term “cluster” is used to refer to any grouping of search results, which may include, for instance, categories of search results, search result types (e.g., news, image, etc.), as well as any other search result aggregation. The clusters allow users to view different search results while remaining within the context of the original search.

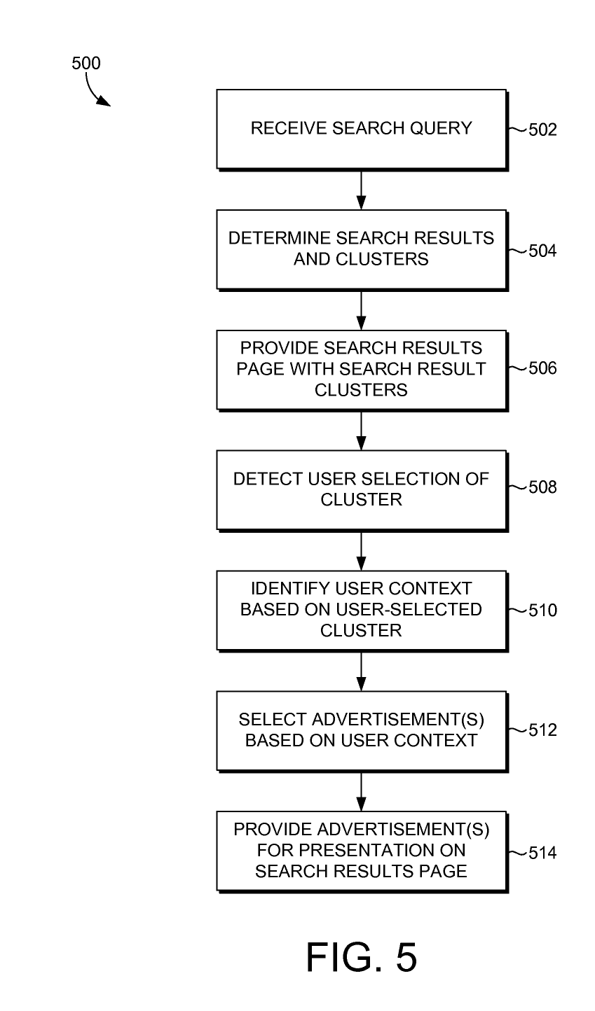

In embodiments, advertisements may be selected based on a user context resulting from a user action associated with a cluster of search results. FIG. 5 provides a flow diagram illustrating a method 500 for providing advertisements based on user actions corresponding with search result clusters in accordance with an embodiment of the present invention.

As shown at block 502, a search query is received from an end user. Search results relevant to the search query are determined, and the search results are aggregated into a number of clusters, as shown at block 504. A number of techniques may be employed for aggregating search results into clusters. In some embodiments, semantic query expansion is performed based on the search query submitted by the end user. This may include generating a number of expanded queries based on the original search query and performing a search using each expanded query. Each search would result in a set of search results, and each set of search results may be considered a cluster.

A search results page is generated that comprises a user interface that allows the end user to navigate the different clusters and view search results within each cluster. The search results page is provided to the end user, as shown at block 506.

A user selection of a cluster within the search results page is detected, as shown at block 508. In response to detecting selection of the cluster, a user context is identified based on the cluster at block 510. In some embodiments, the user context corresponds with the subset of search results within the selected cluster. In other embodiments, each cluster corresponds to a concept to which each search result within the cluster pertains. In such embodiments, the user context may correspond with the concept of the selected cluster. In further embodiments, the selected cluster may have been generated using an expanded query. In such embodiments, the user context may correspond with the expanded query. Any and all such variations are contemplated to be within the scope of embodiments of the present invention.

One or more advertisements are selected based on the current user context, as shown at block 512. In some embodiments, the advertisements are selected based only on the current user context. In other embodiments, the advertisement selection may also take into account previous user contexts within the search results page. For instance, the end user may have previously selected to view other search result clusters within the search results page. Each time the end user selected a cluster, a user context was generated corresponding with the search results of the selected cluster. In embodiments, weighting may be applied to each user context. The weighting may be based on an order of the user contexts, user view time of the user contexts, and/or a variety of other factors. The one or more advertisements are provided for presentation on the search results page at block 514.

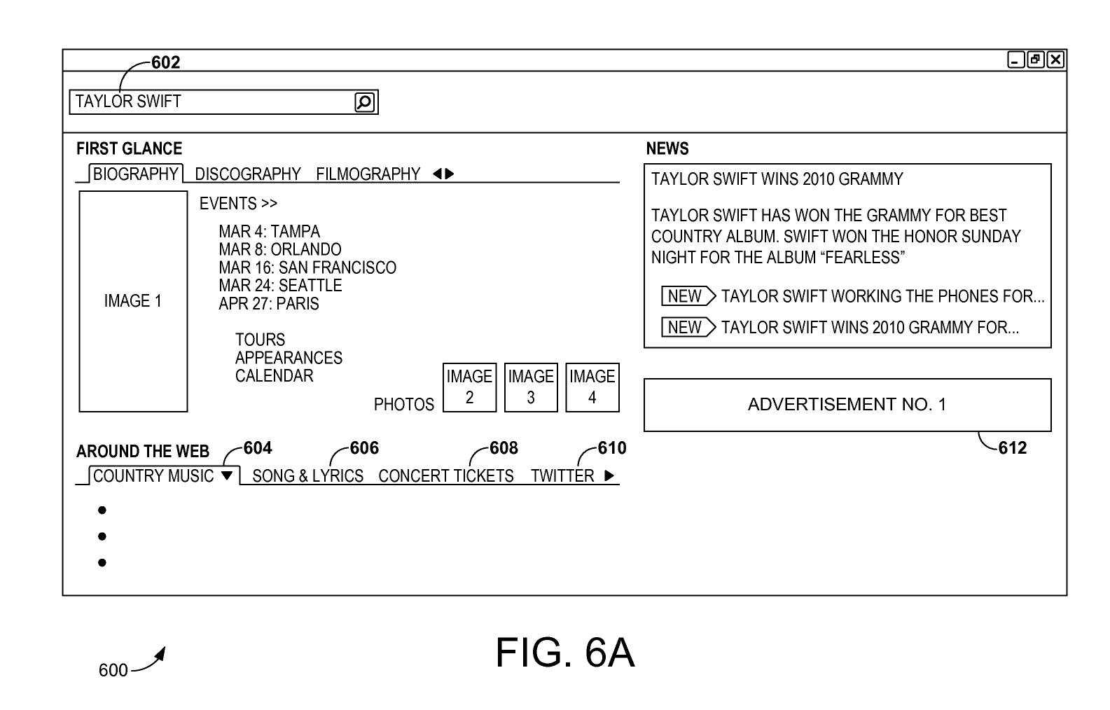

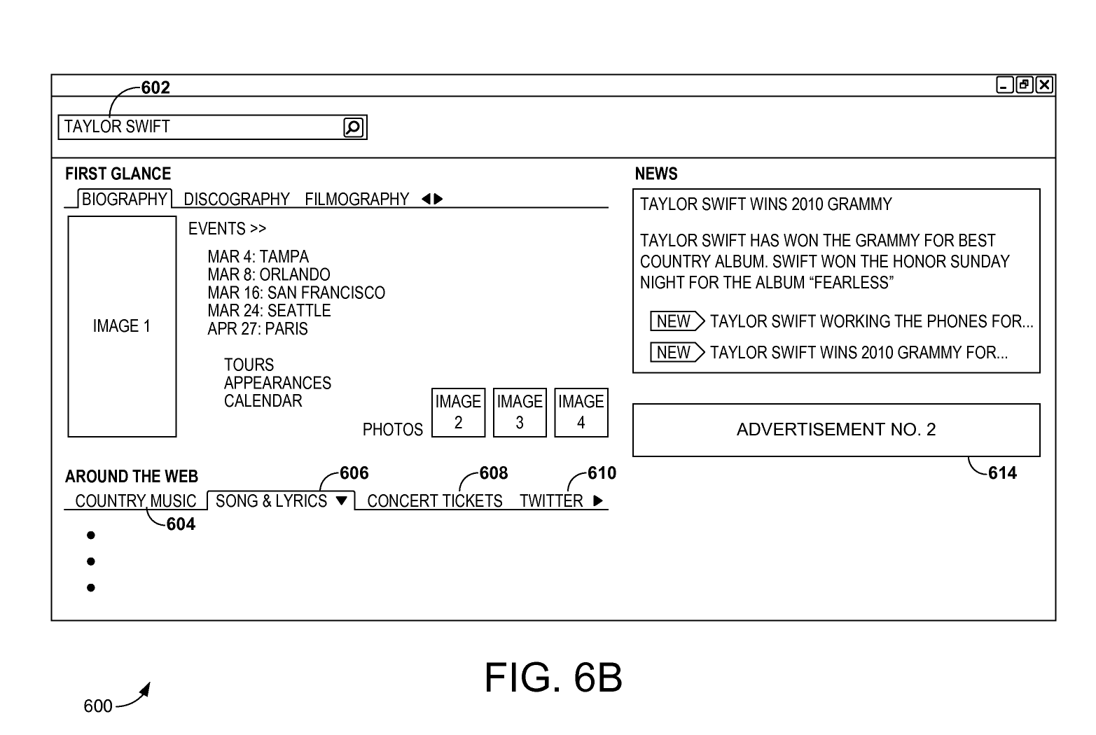

By way of illustration, FIGS. 6A and 6B include exemplary screen displays showing presentation of advertisements selected based on a current search result cluster in accordance with embodiments of the present invention. It will be understood and appreciated by those of ordinary skill in the art that the screen displays of FIGS. 6A and 6B are provided by way of example only and are not intended to limit the scope of the present invention in any way.

Referring initially to FIG. 6A, an exemplary screen display is provided that shows a search results page 600. The search results page 600 includes search results returned in response to the search query “taylor swift” 602. As shown in FIG. 6A, the search results page 600 includes a number of tabs 604, 606, 608, 610. Each tab corresponds with a cluster of search results and includes a title identifying the cluster.

The end user may view search results corresponding with a cluster by selecting one of the tabs 604, 606, 608, 610. In FIG. 6A, the end user has selected the “Country Music” tab 604 such that search results within that cluster are presented on the search results page 600 (search results have been omitted from FIG. 6A for clarity purposes). As such, the user context corresponding with the search results page 600 includes the concept “Country Music” and/or the search results within the “Country Music” cluster. An advertisement 612 has been selected based on the concept “Country Music” and/or the search results within the “Country Music” cluster and is presented on the search results page 600.

FIG. 6B illustrates the search results page 600 after the user has selected the “Songs and Lyrics” tab 606. Search results corresponding with the “Country Music” cluster are no long displayed. Instead, search results corresponding with the “Songs and Lyrics” cluster are now presented within the search results page (search results have been omitted from FIG. 6B for clarity purposes). As such, a new user context is presented corresponding with the “Songs and Lyrics” concept and/or the search results within the “Songs and Lyrics” cluster. A new advertisement 614 has been selected based on the “Songs and Lyrics” cluster and replaces the previous advertisement 612 in the search results page.

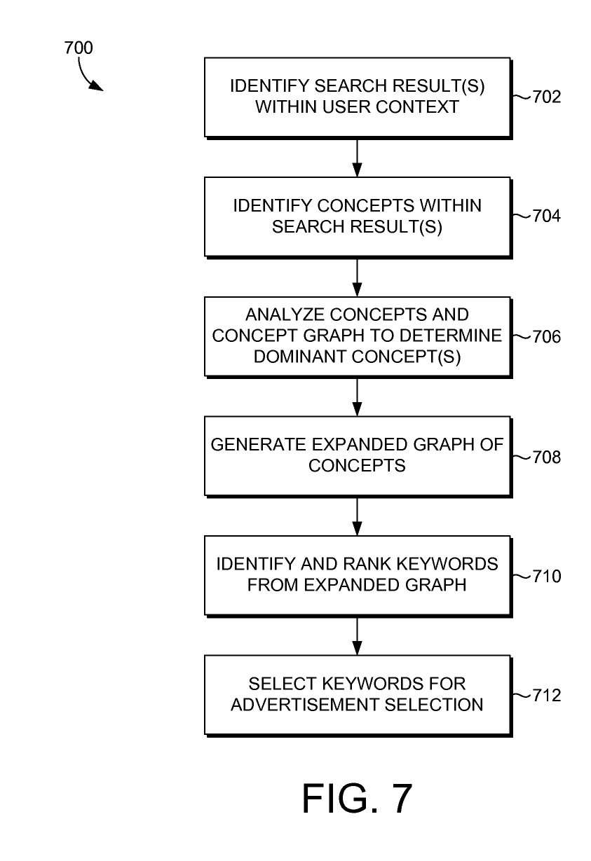

Some embodiments of the present invention select advertisements based on user context by identifying dominant concepts within the user context of the search results page using a concept graph. Referring to FIG. 7, a flow diagram is provided that illustrates a method 700 for identifying dominant concepts in the user context of a search results page and selecting advertisements based on the identified dominant concepts in accordance with an embodiment of the present invention. As shown at block 702, search results within a current user context (and/or previous user contexts) are identified. Concepts within each search result (i.e., the user context) are identified at block 704. Each concept is identified by analyzing text corresponding with the search results to identify the concepts. In various embodiments of the invention, the concepts may be identified from text of search result snippets, documents corresponding with the search results, or other locations.

The concepts are analyzed in conjunction with a concept graph at block 706 to determine dominant concepts. As discussed previously, a concept graph comprises a collection of concepts and relationships among the concepts. Concepts are represented as nodes within the concept graph and relationships among the concepts are represented as edges between the nodes. The edges also represent the strength of relationships between the concepts.

In various embodiments, dominant concepts may be determined based on the frequency with which each concept appears in the text of the search results of the user context and the strength of relationship of concepts within the concept graph. In some embodiments, the strength of relationships of identified concepts to one another is analyzed. In other embodiments, a main concept or topic is identified for the user context (e.g., based on the query context and/or a concept corresponding with a selected cluster) and each concept's strength to the main concept or topic is analyzed.

Any number of dominant concepts may be identified at block 706. In some embodiments, the top N concepts are determined to be dominant concepts. In other embodiments, any concept satisfying a predetermined threshold is determined to be a dominant concept. Any and all such variations are contemplated to be within the scope of embodiments of the present invention.

After identifying one or more dominant concepts, an expanded graph of concepts is generated from the concept graph for each dominant concept, as shown at block 708. In particular, the location of each dominant concept is identified in the concept graph and related concepts that have a strong relationship to the dominant concepts are identified from the concept graph. Based on the expanded graph(s), keywords mapped to the expanded graph(s) are identified and ranked, as shown at block 710. One or more of the ranked keywords are selected for use in advertisement selection at block 712.

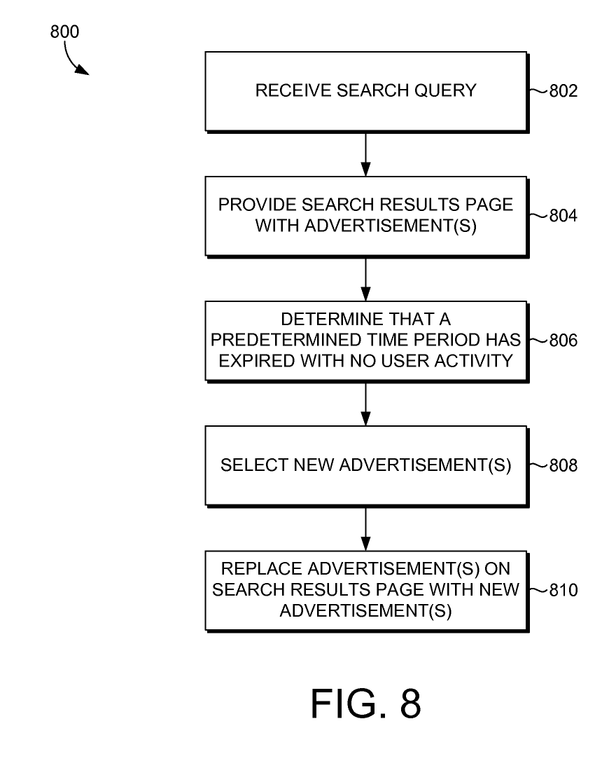

As discussed previously, in some embodiments of the present invention, advertisements may be selected based on the absence of user activity as opposed to being based on the identification of user activity within a search results page. Turning now to FIG. 8, a flow diagram is provided that illustrates a method 800 for selecting an advertisement based on user inactivity within a search results page in accordance with an embodiment of the present invention. Initially, as shown at block 802, a search query is received from an end user. A search results page is provided with one or more advertisements in response to the search query at block 804. It is determined at block 806 that a predetermined period of time has expired in which no user action within the search results page has been detected. In some embodiments, some user activities, such as scrolling up and down a window may not be considered as a user action within the search results page. However, other user activities such as selecting a search result or an advertisement would be considered a user action. The user activities to be tracked to determine whether any user action has occurred for the purposes of the method 800 may be configurable by the search system provider.

The predetermined period of time is also configurable by the search engine provider. In embodiments, the search engine provider may arbitrarily set the predetermined period of time or may select a period of time that satisfies the search engine provider's interests. For instance, the search engine provider may determine a period of time that the search engine provider determines is sufficient for the end user to view the currently displayed advertisements and exhibit no interest in the advertisements based on the absence of user action. In some cases, the search engine provider may collect historical information regarding end user interactions with search results pages, including the time end users spend viewing search results and advertisements, and may use such historical information to select the predetermined time period.

A new set of one or more advertisements is selected at block 808 based on the determination that no user activity has been detected within the predetermined period of time. New advertisements may be selected based on user inactivity using a number of different approaches in various embodiments of the present invention. By way of example only and not limitation, in some embodiments, the new advertisements may be selected from a ranked list of advertisements from which the currently displayed set of advertisements was selected. For instance, only the highest N advertisements may have been previously selected for presentation. Accordingly, new advertisements may be identified by going down the list of ranked advertisements to select the next highest ranked advertisements that were not previously selected.

In another embodiment, new advertisements may be selected by using different keywords for advertisement selection than were used to select the currently presented advertisements. For instance, the process of selecting the currently presented advertisements may have included determining a list of ranked keywords, from which only the top N keywords were used for selecting the currently presented advertisements. In some embodiments, different keywords from the original list of ranked keywords may be employed for selecting new advertisements. In other embodiments, instead of using the original list of keywords, a new set of keywords may be identified. For instance, different algorithms for keyword selection or a different context may be used for the keyword selection. As an example of the latter, the currently displayed advertisements may have been selected using the current user context within the search results page (i.e., what the end user is currently viewing within the search results page). New advertisements may be selected by also taking into account historical user actions within the search results page.

After selecting a set of one or more new advertisements, at least one advertisement currently displayed on the search results page is replaced with a new advertisement, as shown at block 810. In some embodiments, only a single advertisement is displayed on the search results page and that advertisement is replaced with a new advertisement. In other embodiments, the search results page includes multiple advertisements, and the process may replace all or only a portion of the currently displayed advertisements with new advertisements.

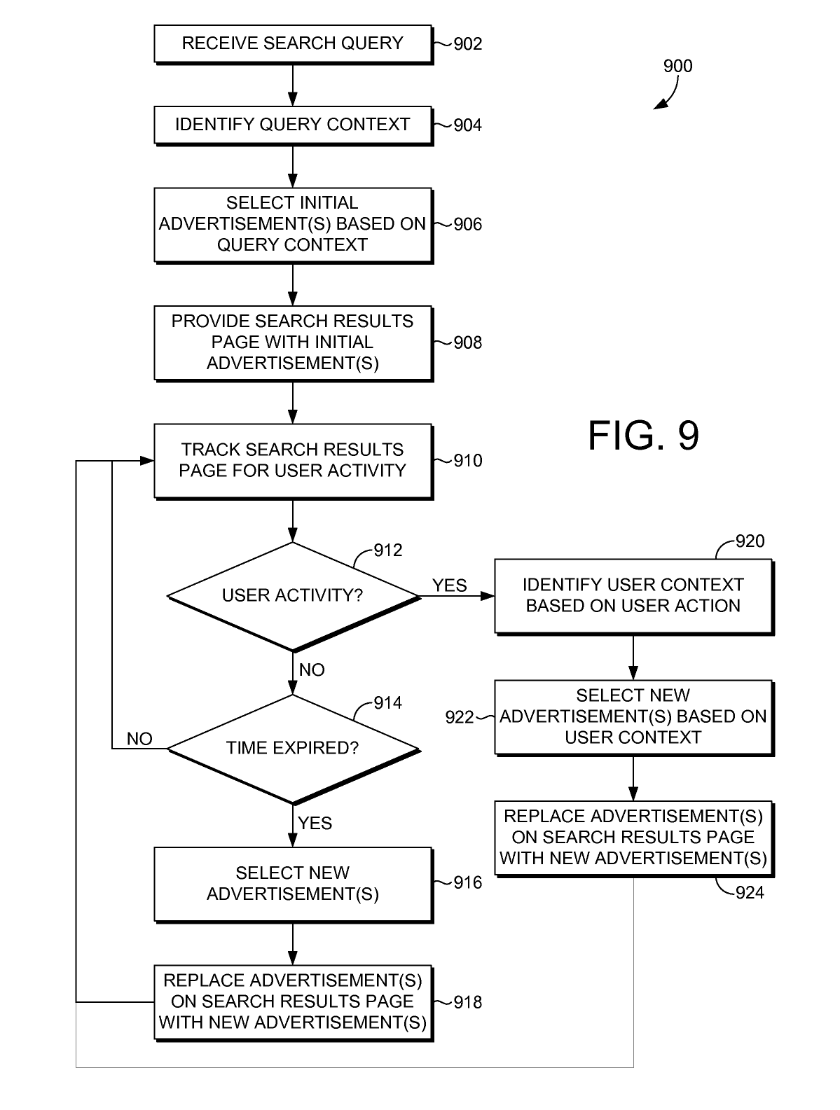

Turning to FIG. 9, a flow diagram is provided that illustrates a method 900 for replacing advertisements on a search results page based on user activity and/or user inactivity in accordance with an embodiment of the present invention. As shown at block 902, a search query is received. A query context is determined for the search query at block 904. The query context may include the search terms included in the search query and/or other information, such as, for instance, a time the search query is submitted or the location of the end user submitting the search query.

An initial set of one or more advertisements is selected based on the query context, as shown at block 906. Additionally, a search results page is generated that includes the initial set of advertisements, and the search results page is provided to the end user, as shown at block 908.

The process continues by tracking the search results page for user action, as shown at block 910. It is determined at block 912 whether any user action has been detected. If no user action is detected, it is determined whether a predetermined time period has expired, as shown at block 914. If the predetermined time period has not expired, the process continues to track the search results page for user action. If the predetermined time period has expired, a new set of one or more advertisements is selected at block 916 based on the absence of user activity within the predetermined period. The new set of advertisements may be selected using any of a number of different approaches, such as those described hereinabove. At least one currently displayed advertisement is replaced with a new advertisement, as shown at block 918.

Alternatively, if user activity is detected at block 912, the process identifies a user context based on the user action, as shown at block 920. A new set of one or more advertisements is selected based on the user context at block 922. The new set of advertisements may be selected using any of a number of different approaches, such as those described hereinabove. At least one currently displayed advertisement is replaced with a new advertisement, as shown at block 924.

As can be understood, embodiments of the present invention are directed to selecting advertisements for presentation within a search results page based on user activity or user inactivity within a search results page. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, cause the one or more computing devices to perform a method comprising:
receiving a search query submitted by an end user;
providing a plurality of search results in response to the search query submitted by the end user, wherein the plurality of search results are grouped into a plurality of clusters, each cluster including a different subset of search results;
identifying a user activity corresponding with one of the plurality of clusters, the user activity being indicative of user interest in a selected cluster;
identifying a user context based on the selected cluster; and
selecting one or more advertisements for presentation based on the user context; and
providing the one or more advertisements for presentation to the end user.

2. The one or more computer-readable media of claim 1, wherein the method further includes selecting one or more initial advertisements based on the search query, and wherein the one or more initial advertisements are provided in conjunction with the plurality of search results.

3. The one or more computer-readable media of claim 2, wherein the one or more advertisements are provided by replacing the one or more initial advertisements with the one or more advertisements.

4. The one or more computer-readable media of claim 1, wherein each subset of search results corresponding with each cluster is provided within a separate tab selectable by the end user, and wherein identifying a user activity corresponding with one of the plurality of clusters comprises identifying a user selection of a tab corresponding with the selected cluster.

5. The one or more computer-readable media of claim 1, wherein selecting the one or more advertisements comprises selecting one or more keywords based on the user context and selecting the one or more advertisements based on the one or more keywords.

6. The one or more computer-readable media of claim 5, wherein selecting the one or more keywords comprises:
identifying a plurality of search results within the user context;
identifying a plurality of concepts within text corresponding with the plurality of search results;
analyzing the plurality of concepts using a concept graph to identify one or more dominant concepts; and
selecting the one or more keywords based on the one or more dominant concepts.

7. The one or more computer-readable media of claim 1, wherein providing the plurality of search results grouped into the plurality of clusters comprises performing a semantic query expansion of the search query submitted by the end user to generate a plurality of expanded queries and performing a search using each expanded query, and wherein the user context is identified based on an expanded query corresponding with the selected cluster.

8. The one or more computer-readable media of claim 1, wherein the one or more advertisements are selected based on at least one previous user context in addition to the user context.

9. The one or more computer-readable media of claim 8, wherein selecting the one or more advertisements comprises weighting each of the user context and the at least one previous user context based on at least one selected from the following: an order in which each user context occurred, and a length of time the end user viewed each user context.

10. One or more computer-readable media storing computer-useable instructions that, when used by one or more computing devices, cause the one or more computing devices to perform a method comprising:
receiving a search query submitted by an end user;
providing a search results page for presentation to the end user in response to the search query submitted by the end user, the search results page including a plurality of search results and an initial advertisement selected based at least in part on the search query submitted by the end user;
tracking the search results page for user activity;
detecting a user action by the end user within the search results page;
responsive to detecting a user action within the search results page, identifying a user context based on the user action;
identifying a set of search results within the user context;
identifying a plurality of concepts within text corresponding with the set of search results within the user context;
analyzing the plurality of concepts using a concept graph to identify one or more dominant concepts;
selecting one or more keywords based on the one more dominant concepts;
selecting a new advertisement based on the one or more keywords; and
replacing the initial advertisement within the search results page with the new advertisement.

11. The one or more computer-readable media of claim 10, wherein the text corresponding with the set of search results comprises at least one selected from the following: a search result snippet for a search result; and a document to which a search result references.

12. The one or more computer-readable media of claim 10, wherein analyzing the plurality of concepts using a concept graph to identify one or more dominant concepts comprises identifying a main topic of the user context and identifying the one or more dominant concepts based on strength of relationship in the concept graph between each of the one or more dominant concepts and the main topic of the user context.

13. The one or more computer-readable media of claim 12, wherein the method further comprises generating an expanded graph for at least one dominant concept and ranking a plurality of keywords based on the expanded graph, wherein the one or more keywords are selected based on the rankings for the plurality of keywords.

14. The one or more computer-readable media of claim 10, wherein the method further comprises:
continuing to track the search results page for user activity after replacing the initial advertisement within the search results page with the new advertisement;
detecting a new user action by the end user within the search results page;
responsive to detecting a new user action within the search results page, identifying a new user context based on the new user action;
selecting a second new advertisement based on the new user context; and
replacing the new advertisement within the search results page with the second new advertisement.

15. One or more computer-readable media storing computer-useable instructions that, when used by one or more computing devices, cause the one or more computing devices to perform a method comprising:
receiving a search query submitted by an end user;
providing a search results page in response to the search query, the search results page including a plurality of search results and an initial advertisement;
determining that a predetermined time period has expired without detecting user activity within the search results page;
responsive to determining that the predetermined time period has expired without detecting user activity within the search results page, selecting a new advertisement; and
replacing the initial advertisement within the search results page with the new advertisement.

16. The one or more computer-readable media of claim 15, wherein the initial advertisement was selected from a list of ranked advertisements, and wherein the new advertisement is selected from the list of ranked advertisements.

17. The one or more computer-readable media of claim 15, wherein the initial advertisement is selected based on a current user context within the search results page, and wherein the new advertisement is selected based on a history of user contexts within the search results page.

18. The one or more computer-readable media of claim 17, wherein each user context in the history of user contexts is weighted based on at least one selected from the following: an order in which each user selection was selected, and a length of time the end user viewed each subset of search results corresponding with each user selection.

19. The one or more computer-readable media of claim 15, wherein the new advertisement is selected using a first algorithm that differs from a second algorithm used to select the initial advertisement.

20. The one or more computer-readable media of claim 15, wherein the initial advertisement is selected using a first subset of one or more keywords selected for a list of ranked keywords and the new advertisement is selected using a second subset of one or more keywords selected from the list of ranked keywords.
